(19) United States
(12) Patent Application Publication
(10) Pub. No.: US 2026/0302234 A1
(43) Pub. Date: Oct. 1, 2026

(54) NEGATIVE ELECTRODE ACTIVE MATERIAL, NEGATIVE ELECTRODE SHEET, SECONDARY BATTERY, AND ELECTRONIC DEVICE

(71) Applicant: Ningde Amperex Technology Limited, Ningde (CN)

(72) Inventor: Wenbo JIN, Ningde (CN)

(73) Assignee: Ningde Amperex Technology Limited, Ningde (CN)

(21) Appl. No.: 19/678,971

(22) Filed: May 15, 2026

Related U.S. Application Data
(63) Continuation of application No. PCT/CN2024/129650, filed on Nov. 4, 2024.

(30) Foreign Application Priority Data
Nov. 16, 2023 (CN) 202311527450.1

(51) Int. Cl. H01M 4/587; C01B 32/21; H01M 4/02; H01M 4/36; H01M 10/0525

(52) U.S. Cl. CPC H01M 4/587; C01B 32/21; H01M 4/366; H01M 10/0525; C01P 2002/82; C01P 2004/03; C01P 2004/80; C01P 2006/11; C01P 2006/12; C01P 2006/40; H01M 2004/021; H01M 2004/027

(57) ABSTRACT

A negative electrode active material, a negative electrode sheet, a secondary battery, and an electronic device. The negative electrode active material includes graphite particles and a silicon carbide layer disposed on a surface of the graphite particles, where a mass percentage Y % of silicon in the negative electrode active material and an average height Lc nm of the negative electrode active material along a c-axis direction satisfy: 0.3×(32−Lc)≤Y≤0.9×(32−Lc). In negative electrode active particles, disposing a silicon carbide layer on the surface of the graphite particles and controlling a thickness of the silicon carbide layer in the negative electrode active material based on the average height of the graphite particles along the c-axis direction can effectively reduce reactions between the graphite particles and an electrolyte, reducing consumption of active ions, and improving the initial coulombic efficiency of the battery.

### CROSS-REFERENCE TO RELATED APPLICATIONS

This application is a continuation application of International Patent Application Serial Number PCT/CN2024/129650, filed on Nov. 4, 2024, which claims priority to the Chinese Patent Application No. 202311527450.1, filed on Nov. 16, 2023, the contents of which are incorporated herein by reference in their entireties.

### TECHNICAL FIELD

This application relates to the field of battery technologies, and in particular, to a negative electrode active material, a negative electrode sheet, a secondary battery, and an electronic device.

### BACKGROUND

Secondary batteries represented by lithium-ion batteries are widely used in digital electronic products, energy storage, drones, electric tools, electric vehicles, and other products due to their high energy density, long cycle life, high safety, and fast charge capability. Currently, the negative electrode active material of lithium-ion batteries is mainly graphite. However, a solid electrolyte interphase film (SEI film) forms during the formation process, resulting in loss of active lithium ions and reducing the initial coulombic efficiency of the battery. Therefore, it is necessary to improve the initial coulombic efficiency of the battery.

### SUMMARY

This application provides a negative electrode active material, a negative electrode sheet, a secondary battery, and an electronic device, to improve the initial coulombic efficiency of the battery by reducing side reactions between the negative electrode active material and the electrolyte.

According to a first aspect, this application provides a negative electrode active material, including graphite particles, and a silicon carbide layer disposed on a surface of the graphite particles, where a mass percentage Y % of silicon in the negative electrode active material and an average height Lc nm of the negative electrode active material along a c-axis direction satisfy: 0.3×(32−Lc)≤Y≤0.9×(32−Lc).

According to this application, disposing a silicon carbide layer on the surface of the graphite particles and controlling a thickness of the silicon carbide layer in the negative electrode active material based on the average height of the graphite particles along the c-axis direction can effectively reduce reactions between the graphite particles and an electrolyte, reducing consumption of active ions, and improving the initial coulombic efficiency of the battery.

In some embodiments, the silicon carbide layer has a thickness of 5 nm to 100 nm, preferably 15 nm to 40 nm.

In some embodiments, a crystal phase of silicon carbide in the silicon carbide layer is β-phase silicon carbide.

In some embodiments, a specific surface area BET m²/g of the negative electrode active material and the mass percentage Y % of silicon in the negative electrode active material satisfy: 1.2≤BET−0.3×Y≤2.0.

In some embodiments, a powder compacted density P g/cm³ of the negative electrode active material after being pressed under a pressure of 5-ton and the mass percentage Y % of silicon in the negative electrode active material satisfy: 1.80≤P+0.08×Y≤2.10.

In some embodiments, a volume-based particle size of the negative electrode active material satisfies: 0.2≤(Dᵥ90−Dᵥ50)/Dᵥ99≤0.5.

In some embodiments, a D-band intensity I_{d} of a Raman spectrum of the negative electrode active material and a G-band intensity I_{g} of the Raman spectrum of the negative electrode active material satisfy: I_{d}/I_{g}<0.5.

In some embodiments, a tap density TD g/cm³ of the negative electrode active material satisfies: 0.7≤TD≤1.2.

In some embodiments, an orientation OI value of the negative electrode active material is less than or equal to 6.

According to a second aspect, this application provides a negative electrode sheet, including a negative electrode film layer, where the negative electrode film layer includes the negative electrode active material according to any one of these embodiments of the first aspect.

In some embodiments, a compacted density PD g/cm³ of the negative electrode sheet satisfies: 1.45≤PD≤1.75.

In some embodiments, a porosity K % of the negative electrode sheet satisfies: 25≤K≤40.

According to a third aspect, this application provides a secondary battery, including the negative electrode sheet according to any one of these embodiments of the second aspect.

According to a fourth aspect, this application provides an electronic device, including the secondary battery according to any one of these embodiments of the third aspect.

### BRIEF DESCRIPTION OF DRAWINGS

The drawings herein are incorporated into this specification and constitute a part of this specification. The drawings illustrate some embodiments that conform to this application, and are used together with the specification to explain the principles of this application.

FIG. 1 is an SEM image of a negative electrode active material in an embodiment of this application.

FIG. 2 is an Si element map for an EDS elemental test of a negative electrode active material in an embodiment of this application.

### DETAILED DESCRIPTION

Some embodiments or implementations in this specification are described in a progressive manner, and each embodiment focuses on differences from other embodiments.

In the description of this specification, the description with reference to terms “one embodiment”, “some embodiments”, “exemplary embodiment”, “example”, “specific example”, or “some examples” means that a specific feature, structure, material, or characteristic described with reference to the embodiment or example is included in at least one embodiment or example of this application. In this specification, the schematic representation of the above terms does not necessarily refer to the same embodiment or example. Moreover, the described specific features, structures, materials, or characteristics may be combined in any suitable manner in any one or more embodiments or examples.

In addition, the terms “first” and “second” are used for descriptive purposes only and are not to be construed as indication or implication of relative importance or implicit indication of a quantity of indicated technical features. Thus, a feature defined with “first” or “second” may explicitly or implicitly include at least one such feature. In the description of this application, “a plurality of” means at least two, such as two, three, or the like, unless otherwise expressly and specifically defined.

In this application, the battery may include a lithium-ion secondary battery, a lithium-ion primary battery, a lithium-sulfur battery, a lithium-sodium ion battery, a sodium-ion battery, a magnesium-ion battery, or the like, which is not limited in some embodiments of this application. The battery may be cylindrical, flat, rectangular parallelepiped, or in other shapes, which is also not limited in some embodiments of this application.

As described in the background above, negative electrode active materials represented by graphite consume active ions due to the formation of an SEI film during the formation process, resulting in reduction of the initial coulombic efficiency of a battery.

Based on the above problems, the related art mainly improves the coulombic efficiency of the battery by increasing a particle size of the negative electrode active material and particle shaping to reduce consumed active ions. However, the above means affect the kinetic performance of the battery, with limited improvement effect and high costs.

Based on this, this application provides a negative electrode active material, a negative electrode sheet, a secondary battery, and an electronic device. The negative electrode active material is less likely to react with the electrolyte. This can reduce the consumption of active ions during the formation process, thereby improving the initial coulombic efficiency of the battery. The implementations of this application are described in detail below.

### Negative Electrode Active Material

According to a first aspect, this application provides a negative electrode active material, including: graphite particles, and a silicon carbide layer disposed on a surface of the graphite particles, where a mass percentage Y % of silicon in the negative electrode active material and an average height Lc nm of the negative electrode active material along a c-axis direction satisfy: 0.3×(32−Lc)≤Y≤0.9×(32−Lc).

According to this application, in a structure of the negative electrode active material, a silicon carbide layer is disposed on the surface of the graphite particles. The silicon carbide layer on the surface of the negative electrode active material can effectively reduce contact between the active surface of the graphite particles and the electrolyte, thereby reducing the formation of the SEI film, decreasing the consumption of active ions, and improving the initial coulombic efficiency (initial efficiency) of the battery. In addition, since silicon carbide exhibits good active ion intercalation/de-intercalation performance, the silicon carbide layer on the surface does not significantly affect the kinetic performance of the battery. The mass percentage Y % of silicon in the negative electrode active material and the average height Lc nm of the negative electrode active material along the c-axis direction satisfy: 0.3×(32−Lc)≤Y≤0.9×(32−Lc). It can be understood that the mass percentage of silicon in the negative electrode active material is positively correlated with a content of silicon carbide in the negative electrode active material. Since a main material of the negative electrode active material is graphite particles, a main factor affecting the average height Lc nm of the negative electrode active material along the c-axis direction is an average height of the graphite particles along the c-axis direction. A higher Lc indicates higher average height of the graphite particles along the c-axis direction, higher crystallinity of the graphite particles, and better stability. A thinner silicon carbide layer can effectively reduce the reactions between the graphite particles and the electrolyte. In addition, when the crystallinity of the graphite particles is high, a volume swelling rate during active ion intercalation is large. Due to the high rigidity of the silicon carbide layer, a thickness of the silicon carbide layer should not be excessively large to accommodate volume swelling of graphite particles with higher crystallinity and improve the stability of the negative electrode active material, thereby reducing the decrease in the initial efficiency caused by cracking of the silicon carbide layer. Based on this, an appropriate silicon carbide content is determined based on the average height Lc of the negative electrode active material along the c-axis direction to improve the initial efficiency of the battery. In addition, since the height of high-crystallinity graphite particles along the c-axis direction is approximately 32 nm, when the mass percentage Y % of silicon in the negative electrode active material and the average height Lc nm of the negative electrode active material along the c-axis direction satisfy: 0.3×(32−Lc)≤Y≤0.9×(32−Lc), the battery has relatively high initial efficiency. It should also be noted that the Lc nm of the negative electrode active material satisfies 0<Lc<32. It should be noted that, due to the good thermal stability of the silicon carbide layer, by reducing the contact between the graphite particles and the electrolyte, the negative electrode active material can further effectively improve a thermal runaway temperature of the battery. The mass percentage of silicon in the negative electrode active material has a meaning known in the art and can be detected according to known methods and instruments. As an example, the mass percentage of silicon in the negative electrode active material may be detected according to GB/T 17359-2012, to be specific, under standard experimental environment and detection standard requirements, the negative electrode active material is placed in a scanning electron microscope sample chamber according to standard operation procedures, a test position is magnified and observed at an acceleration voltage of 15 kV, and a mass percentage of silicon in the sample is quantitatively detected with an X-ray energy spectrometer.

The average height of the negative electrode active material along the c-axis direction has a meaning known in the art and can be detected according to known methods and instruments. As an example, the average height of the negative electrode active material along the c-axis direction can be detected with X-ray diffractometer (XRD). To be specific, the negative electrode active material is tested with an X-ray diffractometer (XRD, instrument model: Bruker D8 ADVANCE), with a target of Cu Kα; voltage and current of 40 kV/40 mA; scanning angle range of 5° to 80°; scanning step of 0.00836°; and time per step of 0.3 s, to obtain an X-ray diffraction pattern of the negative electrode active material, obtain the full width at half maximum of the 002 peak (the full width at 50% between the lowest and highest points of the peak intensity of the 002 peak), and calculate the average height Lc nm of the negative electrode active material along the c-axis direction according to Lc=Kλ/α(2θ)/cos α, where K is the scherrer constant (K=0.9), α is the full width at half maximum of the 002 peak, λ is the wavelength (0.154056), and θ is the angle at the maximum peak intensity of the 002 peak.

In some embodiments, the silicon carbide layer has a thickness of 5 nm to 100 nm.

In the above embodiments, the thickness of the silicon carbide layer is further defined. Since the silicon carbide layer has strong rigidity, the thickness of the silicon carbide layer affects a powder compacted density of the negative electrode active material, which increases a possibility of crushing, and therefore, the thickness should not be excessively large. In addition, a silicon carbide layer with an appropriate thickness can further improve the thermal stability of the negative electrode active material, thereby further improving the thermal runaway temperature of the battery. For example, the thickness of the silicon carbide layer may be 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, or within a range defined by any of the above values. It should also be noted that graphite particles with appropriate crystallinity can be selected based on the appropriate thickness of the silicon carbide layer to further improve the initial efficiency and thermal reliability of the battery.

The thickness of the silicon carbide layer has a meaning known in the art and can be detected according to methods and instruments known in the art. As an example, the thickness of silicon carbide can be observed and calculated by observing the sample through a transmission electron microscope.

In some embodiments, a crystal phase of silicon carbide in the silicon carbide layer is β-phase silicon carbide. The crystal phase of silicon carbide may be β-phase. β-phase silicon carbide not only has good mechanical property but also good active ion intercalation/de-intercalation capability, which can improve the initial efficiency of the battery without significantly affecting the kinetic performance of the battery.

In some embodiments, a specific surface area BET m²/g of the negative electrode active material and the mass percentage Y % of silicon in the negative electrode active material satisfy: 1.2≤BET−0.3×Y≤2.0.

In the above embodiments, the relationship between the specific surface area of the negative electrode active material and the mass percentage of silicon in the negative electrode active material is further defined. Since the silicon carbide layer is disposed on the surface of the graphite particles, an adsorption capacity for nitrogen becomes stronger, thereby increasing the specific surface area of the negative electrode active material. Generally, a higher mass percentage of silicon in the negative electrode active material, that is, a greater content of silicon carbide indicates a larger specific surface area of the negative electrode active material. However, the specific surface area of the graphite particles affects the uniformity of silicon carbide deposition, and after extensive experimentation, the influence factor of the mass percentage of silicon in the negative electrode active material on the specific surface area of the negative electrode active material is determined to be 0.3, that is, BET−0.3×Y can be approximately understood as the specific surface area of the graphite particles. By controlling the specific surface area of the graphite particles, the silicon carbide layer on the surface can be more uniform. When the negative electrode active material satisfies 1.2≤BET−0.3×Y≤2.0, the negative electrode active material consumes fewer active ions during the formation process of the battery, further improving the initial efficiency of the battery. For example, BET−0.3×Y may be 1.2, 1.3, 1.4, 1.5, 1.6, 1.7, 1.8, 1.9, 2.0, or within a range defined by any of the above values.

The specific surface area of the negative electrode active material has a meaning known in the art and can be detected according to methods with instruments known in the art. As an example, detection may be performed with reference to GB/T 19587-2017. To be specific, 1 g to 8 g of sample (the minimum sample weight should cover at least ⅓ of a sphere volume) is placed in a ½-inch long tube with a bulb (a diameter of the spherical tube part is 12 mm), pre-treated at 200° C. for 2 hours, and then placed in a test device TriStar3030 (Micromeritics, USA) for testing. An adsorption gas is N₂ (purity: 99.999%), a test condition is 77 K, and the specific surface area is tested by using the BET calculation method.

In some embodiments, a powder compacted density P g/cm³ of the negative electrode active material after being pressed under a pressure of 5-ton and the mass percentage Y % of silicon in the negative electrode active material satisfy: 1.80≤P+0.08×Y≤2.10.

In the above embodiments, the relationship between the powder compacted density of the negative electrode active material after being pressed under a pressure of 5-ton and the mass percentage of silicon in the negative electrode active material is further defined. As described above, since the silicon carbide layer has strong rigidity, the thickness of the silicon carbide layer affects the powder compacted density of the negative electrode active material. A greater content of silicon carbide indicates a smaller powder compacted density. After extensive experimentation, the influence factor of the mass percentage of silicon in the negative electrode active material on the powder compacted density of the negative electrode active material after being pressed under a pressure of 5-ton is determined to be 0.08, that is, P+0.08×Y can be approximately understood as the powder compacted density of the graphite particles. By controlling the powder compacted density of the graphite particles, the stability of the negative electrode active material can be further improved. When the negative electrode active material satisfies 1.80≤P+0.08×Y≤2.10, the negative electrode active material is less prone to deformation and cracking during cold-pressing, further improving the initial efficiency of the battery. For example, P+0.08×Y may be 1.80, 1.85, 1.90, 1.95, 2.00, 2.05, 2.10, or within a range defined by any of the above values, and further preferably 1.95≤P+0.08×Y≤2.05.

The powder compacted density of the negative electrode active material after being pressed under a pressure of 5-ton has a meaning known in the art and can be detected according to methods and instruments known in the art. As an example, detection may be performed with reference to GB/T 24533-2009. To be specific, 1.0000±0.0500 g of sample is placed in a test mold (CARVER #3619 (13 mm)), and then the sample is placed in a test device. The test device is SUNS UTM7305 with a test tonnage of 5 tons, a pressure increase rate of 10 mm/min, a pressure holding time of 30 s, a pressure release rate of 30 mm/min, and a pressure release holding time of 10 s. A calculation formula of compacted density is as follows: compacted density=mass of negative electrode material/force-bearing area of negative electrode material/sample thickness.

In some embodiments, a volume-based particle size of the negative electrode active material satisfies: 0.2≤(Dᵥ90−Dᵥ50)/Dᵥ99≤0.5.

In the above embodiments, the volume-based particle size distribution of the negative electrode active material is further defined. Generally, an excessively wide particle size distribution of the negative electrode active material decreases the processing performance and coulombic efficiency of the negative electrode active material, and an excessively narrow particle size distribution hinders further improvement of the compacted density of the negative electrode sheet. Therefore, when the volume-based particle size of the negative electrode active material satisfies 0.2≤(Dᵥ90−Dᵥ50)/Dᵥ99≤0.5, the initial efficiency of the battery can be further improved. For example, (Dᵥ90−Dᵥ50)/Dᵥ99 may be 0.2, 0.25, 0.3, 0.35, 0.4, 0.45, 0.5, or within a range defined by any of the above values.

The volume-based particle sizes Dᵥ50, Dᵥ90, and Dᵥ99 of the negative electrode active material have meanings known in the art and can be detected according to methods and instruments known in the art. As an example, detection may be performed with reference to GB/T 19077-2016. To be specific, 1 g of sample was mixed uniformly with 20 mL of deionized water and a trace amount of dispersant. The mixture is sonicated in an ultrasonic device for 5 min, then the solution is poured into a sampling system Hydro 2000SM for testing with a test device Mastersizer 3000 produced by Malvern. During the test, the particle size is measured by measuring the intensity of scattered light when the laser beam passes through the dispersed particle samples. The data are then used to analyze and calculate the particle size distribution that forms the scattered light spectrum. The particle refractive index used in the test is 1.8. One sample is tested three times, and the final particle size is an average of the three tests to obtain Dᵥ50, Dᵥ90, and Dᵥ99.

In some embodiments, a D-band intensity I_{d} of a Raman spectrum of the negative electrode active material and a G-band intensity I_{g} of the Raman spectrum of the negative electrode active material satisfy: I_{d}/I_{g}<0.5.

In the above embodiments, a defect degree of the negative electrode active material is further defined. The I_{d}/I_{g} value can indicate the defect degree of the negative electrode active material. A larger I_{d}/I_{g} value indicates a higher surface defect degree of the negative electrode active material, which increases its side reactions with the electrolyte, thereby affecting the initial efficiency of the battery. Therefore, when I_{d}/I_{g}<0.5, the initial efficiency of the battery can be further improved.

The D-band intensity I_{d} of the Raman spectrum of the negative electrode active material and the G-band intensity I_{g} of the Raman spectrum of the negative electrode active material have meanings known in the art and can be detected according to methods and instruments known in the art. As an example, a laser micro-confocal Raman spectrometer (Raman, HR Evolution, HORIBA Scientific) is used to scan sample particles to obtain the D-band and G-band of all particles within the area. LabSpec software is used to process the data to obtain the D-band and G-band intensities of each particle, which are I_{d} and I_{g} respectively. For I_{d}/I_{g}, the frequency of I_{d}/I_{g} is counted with 0.02 as the step to obtain a normal distribution diagram, and the average of I_{d}/I_{g} is calculated, which is the D-band to G-band intensity ratio I_{d}/I_{g} of the active material. A laser wavelength of the Raman spectrometer may be in the range of 532 nm to 785 nm. The D-band is generally near 1350 cm-1, which is caused by the symmetric stretching vibration, namely, radial breathing mode, of sp2 carbon atoms in aromatic rings (structural defects). The G-band is near 1575 cm-1, caused by the stretching vibration between sp2 carbon atoms, which corresponds to the vibration of E2 g optical phonons in the center of the Brillouin zone (in-plane vibration of carbon atoms).

In some embodiments, a tap density TD g/cm³ of the negative electrode active material satisfies: 0.7≤TD≤1.2.

In the above embodiments, the tap density of the negative electrode active material is further defined. The tap density affects the processing performance of the negative electrode active material. When the tap density TD g/cm³ of the negative electrode active material satisfies 0.7≤TD≤1.2, the negative electrode active material has better processability, and the performance of the obtained negative electrode sheet is more stable. For example, TD may be 0.7, 0.8, 0.9, 1.0, 1.1, 1.2, or within a range defined by any of the above values.

The tap density of the negative electrode active material has a meaning known in the art and can be detected according to methods and instruments known in the art. As an example, 50 g of powder are loaded into a measuring cylinder; then the measuring cylinder containing the powder is fastened on an instrument for vibration; after vibration, a volume is visually measured according to the height of the powder surface; then a tap density is calculated. The test device may be Bettersize BT-301.

In some embodiments, an orientation OI value of the negative electrode active material is less than or equal to 6.

In the above embodiments, the orientation OI value of the negative electrode active material is further defined. A larger OI value indicates a higher orientation of the negative electrode active material. High orientation means that the intercalation/de-intercalation direction of active ions in the negative electrode active material is relatively uniform, which hinders the intercalation/de-intercalation of active ions, thereby affecting the kinetic performance of the battery. Therefore, when the OI value of the negative electrode active material is less than or equal to 6, the kinetic performance of the battery is better.

The orientation OI value of the negative electrode active material has a meaning known in the art and can be detected according to methods and instruments known in the art. As an example, the X-ray diffraction patterns of the (004) plane diffraction pattern and the (110) plane diffraction pattern of the negative electrode active material layer may be tested with reference to the industry standard JB/T 4220-2011. The specific test conditions are as follows: CuKα radiation is used as the X-ray source, and CuKα radiation is removed by a filter or monochromator. An operating voltage of the X-ray tube is (30 to 35) kV, and an operating current is (15 to 20) mA. A scanning speed of a counter is ¼°/min. In recording of the 004 diffraction pattern, a scanning range of a diffraction angle 20 is 53° to 57°. In recording of the 110 diffraction pattern, a scanning range of the diffraction angle 20 is 75° to 79°. A peak area obtained from the (004) plane diffraction pattern is recorded as C004. A peak area obtained from the (110) plane diffraction pattern is recorded as C110. A ratio of C004/C110 of the negative electrode active material is calculated, which is the OI value of the negative electrode active material.

### Method for Preparing Negative Electrode Active Material

The negative electrode active material in the first aspect may be prepared using methods and instruments known in the art. As an example, it may be prepared by using the following method.

Preparation of graphite particles: Petroleum coke may be used as a raw material for graphite particles, with a sulfur content of petroleum coke less than 1%. The petroleum coke is crushed to Dᵥ50 of 9 μm to 12 μm, and then subjected to pre-carbonization treatment at a treatment temperature of 900° C. to 1100° C. for a treatment time greater than or equal to 6 h. Then the treated sample is graphitized. The graphitization process refers to controlling a temperature and time of graphitization. The graphitization temperature is controlled to be 2700° C. to 3000° C. The holding time is controlled to be 36 h to 72 h. After graphitization is completed, the material undergoes shaping and classification to narrow its particle size range, with shaping and classification time of 3 h to 8 h. According to actual powder parameter requirements, a yield is adjusted, and a classification yield is 50% to 90%. In this way, graphite particles are obtained. It can be understood that different graphite particles can be obtained by controlling the above process parameters.

Preparation of negative electrode active material: Appropriate graphite particles are subjected to vapor deposition coating. A vapor deposition temperature is selected to be 900° C. to 1200° C. Argon (Ar) is selected as a carrier gas. Silane and acetylene are selected as reaction gases, and a flow rate ratio of silane to acetylene is controlled to be 5:4. A flow rate of silane is controlled to be 25 sccm to 75 sccm, a flow rate of acetylene is controlled to be 20 sccm to 60 sccm, and a deposition time is controlled to be 3 h to 15 h. The gas flow rate and reaction time are controlled to control a coating thickness of a silicon carbide deposition layer on the surface of the graphite particles.

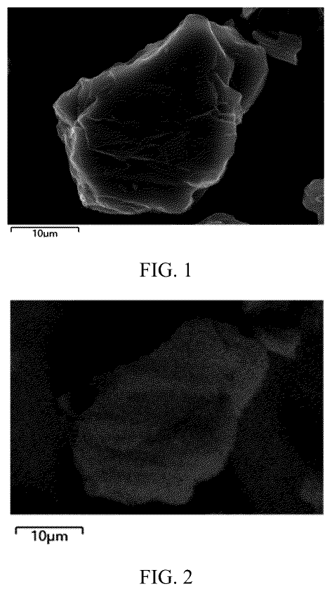

FIG. 1 is an SEM image of a negative electrode active material in an embodiment of this application, and its morphology has no obvious difference from that of ordinary graphite particles, indicating that the silicon carbide layer does not significantly affect the morphology of the graphite particles. FIG. 2 is an Si element map for an EDS elemental test of a negative electrode active material in an embodiment of this application, where red indicates the presence of Si element, and it can be learned that the graphite particles are fully coated with silicon carbide, indicating that the deposition effect of silicon carbide is good.

### Negative Electrode Sheet

According to a second aspect, this application provides a negative electrode sheet, including a negative electrode film layer, where the negative electrode film layer includes the negative electrode active material according to any one of these embodiments of the first aspect.

According to this application, since the negative electrode sheet includes the silicon-carbon negative electrode material according to any one of these embodiments of the first aspect, it has the beneficial effects of the first aspect.

In some embodiments, a compacted density PD g/cm³ of the negative electrode sheet satisfies: 1.45≤PD≤1.75.

In the above embodiments, the compacted density of the negative electrode sheet is further defined. If the compacted density is excessively large, the negative electrode active material may crack, leading to micro-cracks, resulting in an increase in a film-forming reaction surface and affecting the initial efficiency of the battery. If the compacted density is excessively small, the contact in the negative electrode active material is poor, and the electronic conductivity is reduced, which also affects the initial efficiency of the battery. When the compacted density of the negative electrode sheet satisfies 1.45≤PD≤1.75, the initial efficiency of the battery is further improved.

In some embodiments, a porosity K % of the negative electrode sheet satisfies: 25≤K≤40.

In the above embodiments, a porosity of the negative electrode sheet is further defined. It can be understood that the porosity is related to infiltration performance of the electrolyte, that is, related to transport of active ions and electron transport within the negative electrode active material. When the porosity of the negative electrode sheet satisfies 25≤K≤40, the initial efficiency of the battery is further improved.

In some embodiments, the negative electrode current collector may be a metal foil or a composite current collector. For example, the metal foil may be a copper foil. The composite current collector may include a polymer material substrate and a metal layer formed on at least one surface of the polymer material substrate. The composite current collector may be formed by forming a metal material (copper, copper alloy, nickel, nickel alloy, titanium, titanium alloy, silver, silver alloy, or the like) on the polymer material substrate (such as polypropylene (PP), polyethylene terephthalate (PET), polybutylene terephthalate (PBT), polystyrene (PS), or polyethylene (PE)).

In some embodiments, the negative electrode film layer may optionally further include a binder. The binder may be selected from at least one of styrene-butadiene rubber (SBR), polyacrylic acid (PAA), sodium polyacrylate (PAAS), polyacrylamide (PAM), polyvinyl alcohol (PVA), sodium alginate (SA), polymethacrylic acid (PMAA), or carboxymethyl chitosan (CMCS).

In some embodiments, the negative electrode film layer may optionally further include a conductive agent. The conductive agent may be selected from at least one of superconducting carbon, acetylene black, carbon black, Ketjen black, carbon dots, carbon nanotubes, graphene, or carbon nanofiber.

In some embodiments, the negative electrode film layer may optionally further include other additives, such as a thickener (such as sodium carboxymethyl cellulose (CMC-Na)).

In some embodiments, the negative electrode sheet may be prepared in the following manner: the above components for preparing the negative electrode sheet, such as the negative electrode active material, conductive agent, binder, and any other components, are dispersed in a solvent (such as deionized water) to form a negative electrode slurry; the negative electrode slurry is applied to a negative electrode current collector; and after drying, cold-pressing, and other processes, a negative electrode sheet is obtained.

According to a third aspect, this application provides a secondary battery, including the negative electrode sheet according to any one of these embodiments of the second aspect.

According to this application, since the battery includes the negative electrode sheet according to any one of these embodiments of the second aspect, the battery has the beneficial effects of the second aspect.

Generally, the battery includes a positive electrode sheet, a negative electrode sheet, an electrolyte, and a separator.

### [Positive Electrode Sheet]

The positive electrode sheet includes a positive electrode current collector and a positive electrode film layer disposed on at least one surface of the positive electrode current collector, and the positive electrode film layer includes a positive active material.

As an example, the positive electrode current collector has two surfaces opposite in its thickness direction, and the positive electrode film layer is disposed on either or both of the two opposite surfaces of the positive electrode current collector.

In some embodiments, the positive electrode current collector may be a metal foil or a composite current collector. For example, the metal foil may be an aluminum foil. The composite current collector may include a polymer material substrate and a metal layer formed on at least one surface of the polymer material substrate. The composite current collector may be formed by forming a metal material (aluminum, aluminum alloy, nickel, nickel alloy, titanium, titanium alloy, silver, silver alloy, or the like) on the polymer material substrate (such as polypropylene (PP), polyethylene terephthalate (PET), polybutylene terephthalate (PBT), polystyrene (PS), or polyethylene (PE)).

In some embodiments, the positive active material may be a positive active material known in the art for batteries. As an example, the positive active material may include at least one of the following materials: lithium-containing phosphate with an olivine structure, lithium transition metal oxide, and their respective modified compounds. However, this application is not limited to these materials, and other conventional materials that can be used as positive active materials for batteries may be used. These positive active materials may be used alone or in combination of two or more. Examples of lithium transition metal oxides may include, but are not limited to, at least one of lithium cobalt oxide (such as LiCoO₂), lithium nickel oxide (such as LiNiO₂), lithium manganese oxide (such as LiMnO₂ and LiMn₂O₄), lithium nickel cobalt oxide, lithium manganese cobalt oxide, lithium nickel manganese oxide, lithium nickel cobalt manganese oxide (such as LiNi_{1/3}Co_{1/3}Mn_{1/3}O₂ (also referred to as NCM333), LiNi_{0.5}Co_{0.2}Mn_{0.3}O₂ (also referred to as NCM523), LiNi_{0.5}Co_{0.25}Mn_{0.25}O₂ (also referred to as NCM211), LiNi_{0.6}Co_{0.2}Mn_{0.2}O₂ (also referred to as NCM622), LiNi_{0.8}Co_{0.1}Mn_{0.1}O₂ (also referred to as NCM811)), lithium nickel cobalt aluminum oxide (such as LiNi_{0.85}Co_{0.15}Al_{0.05}O₂), their modified compounds, or the like. Examples of lithium-containing phosphate with an olivine structure may include, but are not limited to, at least one of lithium iron phosphate (such as LiFePO4 (also referred to as LFP)), a composite material of lithium iron phosphate and carbon, lithium manganese phosphate (such as LiMnPO4), a composite material of lithium manganese phosphate and carbon, lithium manganese iron phosphate, or a composite material of lithium manganese iron phosphate and carbon.

In some embodiments, the positive electrode film layer may optionally further include a binder. As an example, the binder may include at least one of polyvinylidene fluoride (PVDF), polytetrafluoroethylene (PTFE), vinylidene fluoride-tetrafluoroethylene-propylene terpolymer, vinylidene fluoride-hexafluoropropylene-tetrafluoroethylene terpolymer, tetrafluoroethylene-hexafluoropropylene copolymer, or fluorine-containing acrylate resin.

In some embodiments, the positive electrode film layer may optionally further include a conductive agent. As an example, the conductive agent may include at least one of superconducting carbon, acetylene black, carbon black, Ketjen black, carbon dots, carbon nanotubes, graphene, or carbon nanofiber.

In some embodiments, the positive electrode sheet can be prepared in the following manner: the above components for preparing the positive electrode sheet, such as the positive active material, conductive agent, binder, and any other components, are dispersed in a solvent (such as N-methylpyrrolidone) to form a positive electrode slurry; the positive electrode slurry is applied to a positive electrode current collector, and after drying, cold-pressing, and other processes, the positive electrode sheet is obtained.

### [Negative Electrode Sheet]

This is determined according to any one of these embodiments of the second aspect.

### [Separator]

The separator is disposed between the positive electrode sheet and the negative electrode sheet, mainly to prevent short circuit between the positive electrode and negative electrode while allowing for passage of active ions. A type of the separator is not particularly limited in this application, and any porous structure separator with good chemical stability and mechanical stability known in the art may be used.

In some embodiments, the material of the separator may be selected from one or more of glass fiber, non-woven fabric, polyethylene, polypropylene, and polyvinylidene fluoride, but is not limited thereto. Optionally, a material of the separator may include polyethylene and/or polypropylene. The separator may be a single-layer film or a multi-layer composite film. When the separator is a multi-layer composite film, the materials of the layers may be the same or different. In some embodiments, a ceramic coating or a metal oxide coating may further be provided on the separator.

### [Electrolyte]

The electrolyte conducts active ions between the positive electrode sheet and the negative electrode sheet. The electrolyte that can be used in the secondary battery in this application may be an electrolyte known in the prior art.

In some embodiments, the electrolyte may include an organic solvent, an electrolyte salt, and an optional additive, and types of organic solvent, lithium salt, and additive are not specifically limited and may be selected according to requirements.

In some embodiments, the secondary battery is a lithium-ion battery, and the electrolyte salt may include a lithium salt. As an example, the lithium salt includes but is not limited to at least one of LiPF₆ (lithium hexafluorophosphate), LiBF₄ (lithium tetrafluoroborate), LiClO₄ (lithium perchlorate), LiFSI (lithium bis(fluorosulfonyl)imide), LiTFSI (lithium bis(trifluoromethanesulfonyl)imide), LiTFS (lithium trifluoromethanesulfonate), LiDFOB (lithium difluoro (oxalato) borate), LiBOB (lithium bis(oxalato) borate), LiPO₂F₂ (lithium difluorophosphate), LiDODFP (lithium difluorobis(oxalato)phosphate), or LiOTFP (lithium tetrafluoro (oxalato)phosphate). The above lithium salts may be used alone or in combination of two or more.

In some embodiments, the secondary battery is a sodium-ion battery, and the electrolyte salt may include a sodium salt. As an example, the sodium salt may be selected from at least one of NaPF₆, NaClO₄, NaBCl₄, NaSO₃CF₃, or Na(CH₃)C₆H₄SO₃.

In some embodiments, as an example, the organic solvent includes but is not limited to at least one of ethylene carbonate (EC), propylene carbonate (PC), ethyl methyl carbonate (EMC), diethyl carbonate (DEC), dimethyl carbonate (DMC), dipropyl carbonate (DPC), methyl propyl carbonate (MPC), ethyl propyl carbonate (EPC), butylene carbonate (BC), fluoroethylene carbonate (FEC), methyl formate (MF), methyl acetate (MA), ethyl acetate (EA), propyl acetate (PA), methyl propionate (MP), ethyl propionate (EP), propyl propionate (PP), methyl butyrate (MB), ethyl butyrate (EB), 1,4-butyrolactone (GBL), sulfolane (SF), dimethyl sulfone (MSM), ethyl methyl sulfone (EMS), or diethyl sulfone (ESE). The above organic solvents may be used alone or in combination of two or more. Optionally, two or more of the above organic solvents are used simultaneously.

In some embodiments, the additive may include a negative electrode film-forming additive, and a positive electrode film-forming additive, and may further include additives capable of improving certain performance of the battery, such as additives that improve overcharge performance of the battery, additives that improve high-temperature or low-temperature performance of the battery, and the like.

As an example, the additive includes but is not limited to at least one of fluoroethylene carbonate (FEC), vinylene carbonate (VC), vinyl ethylene carbonate (VEC), ethylene sulfate (DTD), propylene sulfate, ethylene sulfite(ES), 1,3-propane sultone (PS), 1,3-propene sultone (PST), sulfonate cyclic quaternary ammonium salt, succinic anhydride, succinonitrile (SN), adiponitrile (AND), tris(trimethylsilane) phosphate (TMSP), or tris(trimethylsilane) borate (TMSB).

The electrolyte may be prepared according to conventional methods in the art. For example, the organic solvent, electrolyte salt, and optional additive may be mixed uniformly to obtain the electrolyte. An addition order of the materials is not particularly limited. For example, the electrolyte salt and optional additive are added to the organic solvent and mixed uniformly to obtain the electrolyte; or the electrolyte salt is first added to the organic solvent, and then the optional additive is added to the organic solvent and mixed uniformly to obtain the electrolyte.

### [Electronic Device]

According to a fourth aspect, this application provides an electronic device, including the secondary battery according to any one of these embodiments of the third aspect.

According to this application, since the electronic device includes the secondary battery according to any one of these embodiments of the third aspect, the electronic device has the beneficial effects of the third aspect.

The electronic device in this application is not particularly limited, and it may be any electronic device known in the prior art. In some embodiments, the electronic device may include, but is not limited to, notebook computers, pen input computers, mobile computers, e-book players, portable phones, portable fax machines, portable copiers, portable printers, stereo headphones, video recorders, liquid crystal display televisions, portable cleaners, portable CD players, mini discs, transceivers, electronic notebooks, calculators, memory cards, portable recorders, radios, backup power supplies, motors, automobiles, motorcycles, electric bicycles, bicycles, lighting fixtures, toys, game consoles, clocks, electric tools, flashlights, cameras, large household batteries, lithium-ion capacitors, and the like.

The following describes some embodiments of this application. These embodiments described below are exemplary and are only used to explain this application, and should not be construed as limitations to this application. Where specific techniques or conditions are not indicated in these embodiments, the techniques or conditions described in the literature in the art or the product specification shall be followed. Reagents or instruments used without indicating the manufacturer are conventional products that can be obtained commercially.

Test for initial coulombic efficiency of battery: An assembled lithium-ion battery was subjected to formation and capacity test. The lithium-ion battery was charged at a rate of 0.2C until a voltage reached 3.6 V and a current was lower than 0.05C to obtain a charge capacity Q1. Then, the lithium-ion battery was left standing for 5 min. Then, the lithium-ion battery was discharged at a rate of 0.2C until the voltage reached 2.5 V to obtain the discharge capacity Q2. Initial coulombic efficiency=Q2/Q1×100%.

Test for battery thermal runaway temperature: First, the battery was fully charged and then placed in a high-temperature chamber. An initial temperature of the high-temperature chamber was 25° C., and the temperature was increased at a heating speed of 5° C./min to a set temperature, where the set temperature was 120° C. to 180° C., and then the temperature was hold for 60 min. If the battery smoked, caught fire, or even exploded, it was determined that thermal runaway occurred; otherwise, it was determined that thermal runaway did not occur.

### Example 1-1

Preparation of graphite particles: Petroleum coke was used as a raw material for graphite particles, with a sulfur content of petroleum coke less than 0.8%. The petroleum coke was crushed to Dᵥ50 of 10 μm, and then subjected to pre-carbonization treatment at a treatment temperature of 950° C. for a treatment time of 8 h. Then, the treated sample was graphitized. The graphitization process referred to controlling a temperature and time of graphitization. The graphitization temperature was controlled to be 2900° C. A holding time was controlled to be 48 h. After graphitization was completed, the material underwent shaping and classification to narrow its particle size range, with shaping and classification time of 4 h. A classification yield was controlled to be 65%. In this way, graphite particles were obtained.

Preparation of negative electrode active material: The prepared graphite particles were subjected to vapor deposition coating. A vapor deposition temperature was selected to be 1000° C. Argon (Ar) was selected as a carrier gas. Silane and acetylene were selected as reaction gases, and a flow rate ratio of silane to acetylene was controlled to be 5:4. A flow rate of silane was controlled to be 45 sccm, a flow rate of acetylene was controlled to be 36 sccm, and a deposition time was controlled to be 4 h. In this way, the negative electrode active material was obtained. Other parameters were shown in Table 1.

Preparation of negative electrode sheet: A negative electrode active material, conductive carbon, a binder styrene-butadiene rubber (abbreviated as SBR), and a thickener sodium carboxymethyl cellulose (abbreviated as CMC) were mixed in a certain ratio, where a mass percentage of the conductive carbon was 1.5%, a mass percentage of the negative electrode active material was 96%, a mass percentage of the binder styrene-butadiene rubber (abbreviated as SBR) was 1.5%, and a mass percentage of the thickener sodium carboxymethyl cellulose (abbreviated as CMC) was 1.0%. Then, the resulting mixture was fully stirred and mixed in an appropriate amount of deionized water solvent to form a uniform negative electrode slurry. This slurry was applied to a current collector Cu foil, dried, and cold-pressed to obtain a negative electrode sheet.

Preparation of positive electrode sheet: Lithium iron phosphate was used as a positive active material and fully stirred and mixed with a conductive agent acetylene black and a binder polyvinylidene fluoride (abbreviated as PVDF) at a weight ratio of 96.3:2.2:1.5 in an appropriate amount of N-methylpyrrolidone (abbreviated as NMP) solvent to form a uniform positive electrode slurry. This slurry was applied to a current collector Al foil, dried, and cold-pressed to obtain a positive electrode sheet.

Preparation of electrolyte: In a dry argon atmosphere glove box, ethylene carbonate (EC), propylene carbonate (PC), ethyl methyl carbonate (EMC), and diethyl carbonate (DEC) were mixed at a mass ratio of EC:EMC:DEC=1:3:3:3; then 1,3-propane sultone was added, dissolved, and fully stirred; then a lithium salt LiPF₆ was added and mixed well to obtain an electrolyte. A mass percentage of LiPF₆ was 11.0%, a mass percentage of 1,3-propane sultone was 2.9%, and mass percentages of substances were calculated based on a mass of the electrolyte.

Preparation of separator: An 8-μm PE porous polymer film was used as the separator.

Preparation of lithium-ion battery: The above negative electrode sheet, positive electrode sheet, and separator were wound, placed in an aluminum plastic film, then injected with electrolyte, left standing, and undergoing formation to produce a lithium-ion secondary battery.

The initial coulombic efficiency and thermal runaway temperature of the above lithium-ion battery were tested, and the results were shown in Table 1.

### Examples 1-2 to 1-9 and Comparative Examples 1 to 6

These examples and comparative examples were substantially the same as Example 1-1, except that the graphitization process and vapor deposition conditions were controlled, and the thickness of the silicon carbide layer, Lc, and Y of the negative electrode active material were changed. The graphitization temperature and time affected the size of Lc. Increasing the temperature and holding time increases Lc, and decreasing the temperature and holding time decreases Lc. Specific parameters were shown in Table 1.

The initial coulombic efficiency and thermal runaway temperature of the above lithium-ion batteries were tested, and the results were shown in Table 1.

TABLE 1

| | | | Thickness | | | | | | Thermal |
|---|---|---|---|---|---|---|---|---|---|
| | Graphitization | Holding | of silicon | | 0.3 × | 0.9 × | | Initial | runaway |
| | temperature | time | carbide layer | | (32 − | (32 − | | efficiency | temperature |
| | (° C.) | (h) | (nm) | Lc | Lc) | Lc) | Y | (%) | (° C.) |
| Example 1-1 | 2900 | 48 | 30 | 28.5 | 1.05 | 3.15 | 2.5 | 91.2 | 165 |
| Example 1-2 | 2800 | 48 | 45 | 27.5 | 1.35 | 4.05 | 2.9 | 91.1 | 163 |
| Example 1-3 | 3000 | 39 | 55 | 26.8 | 1.56 | 4.68 | 3.1 | 91 | 164 |
| Example 1-4 | 3000 | 40 | 35 | 28.2 | 1.14 | 3.42 | 1.9 | 91.1 | 163 |
| Example 1-5 | 3000 | 38 | 48 | 28 | 1.2 | 3.6 | 2.6 | 91.2 | 163 |
| Example 1-6 | 2900 | 36 | 56 | 27.5 | 1.35 | 4.05 | 2.9 | 91 | 162 |
| Example 1-7 | 2900 | 45 | 45 | 28 | 1.2 | 3.6 | 3.3 | 91.1 | 163 |
| Example 1-8 | 2800 | 38 | 85 | 24.7 | 2.19 | 6.57 | 4.8 | 90.9 | 164 |
| Example 1-9 | 3000 | 36 | 97 | 23.5 | 2.55 | 7.65 | 5.9 | 90.7 | 163 |
| Comparative | 3000 | 46 | 2 | 31.5 | 0.15 | 0.45 | 0.8 | 87.3 | 132 |
| example 1 | | | | | | | | | |
| Comparative | 2900 | 36 | 90 | 24.9 | 2.13 | 6.39 | 6.5 | 87.2 | 133 |
| example 2 | | | | | | | | | |
| Comparative | 2950 | 46 | 13 | 29.8 | 0.66 | 1.98 | 2.2 | 87 | 130 |
| example 3 | | | | | | | | | |
| Comparative | 2700 | 48 | 12 | 24.9 | 2.13 | 6.39 | 2.0 | 87.1 | 131 |
| example 4 | | | | | | | | | |
| Comparative | 3000 | 44 | 17 | 29.3 | 0.81 | 2.43 | 2.6 | 86.9 | 130 |
| example 5 | | | | | | | | | |
| Comparative | 2900 | 41 | 88 | 26.9 | 1.53 | 4.59 | 5.3 | 87 | 133 |
| example 6 | | | | | | | | | |

According to Table 1, the initial efficiency and thermal runaway temperature of the lithium-ion batteries obtained in the examples are higher than those in the comparative examples, indicating that the negative electrode active material provided in this application can effectively improve the initial efficiency and thermal stability of the battery. In the comparative examples, since Lc and Y do not satisfy the requirements, the silicon carbide layer may not effectively protect the negative electrode active material, or the silicon carbide layer may not well accommodate the swelling of the graphite particles, leading to cracking, thereby reducing the initial efficiency and thermal runaway temperature.

### Examples 2-1 to 2-7

These examples were substantially the same as Example 1-1, except that the vapor deposition conditions were controlled and BET and Y of the negative electrode active material were changed. Specific parameters were shown in Table 2.

The initial coulombic efficiency and thermal runaway temperature of the above lithium-ion batteries were tested, and the results were shown in Table 2.

TABLE 2

| | Vapor | | | | | | Thermal |
|---|---|---|---|---|---|---|---|
| | deposition | Deposition | | | | Initial | runaway |
| | temperature | time | | | BET − | efficiency | temperature |
| | (° C.) | (h) | BET | Y | 0.3Y | (%) | (° C.) |
| Example 1-1 | 1000 | 4 | 2.15 | 2.5 | 1.4 | 91.2 | 165 |
| Example 2-1 | 900 | 9 | 2.03 | 2.3 | 1.34 | 91.4 | 167 |
| Example 2-2 | 1100 | 6 | 2.35 | 2.8 | 1.51 | 91.5 | 167 |
| Example 2-3 | 1000 | 12 | 2.5 | 3 | 1.6 | 91.6 | 168 |
| Example 2-4 | 900 | 8 | 2.6 | 2.5 | 1.85 | 91.4 | 166 |
| Example 2-5 | 1200 | 3 | 2.61 | 2.2 | 1.95 | 91.5 | 167 |
| Example 2-6 | 900 | 5 | 1.5 | 1.5 | 1.05 | 90.6 | 160 |
| Example 2-7 | 900 | 3 | 2.39 | 1.2 | 2.03 | 90.7 | 161 |

According to Table 2, the relationship between the specific surface area of the negative electrode active material and the mass percentage of silicon also affects the initial efficiency and thermal runaway temperature of the battery. When BET−0.3Y satisfies 1.2 to 2, the initial efficiency and thermal runaway temperature of the battery are better.

### Examples 3-1 to 3-6

These examples were substantially the same as Example 2-3, except that: the crushing size of petroleum coke, deposition process, and vapor deposition conditions were adjusted, and P and Y of the negative electrode active material were changed. Specific parameters were shown in Table 3.

The initial coulombic efficiency and thermal runaway temperature of the above lithium-ion batteries were tested, and the results were shown in Table 3.

TABLE 3

| | Petroleum | | | | | | | |
|---|---|---|---|---|---|---|---|---|
| | coke | Vapor | | | | | | Thermal |
| | crushing | deposition | Deposition | | | | Initial | runaway |
| | size Dᵥ50 | temperature | time | | | P + | efficiency | temperature |
| | (μm) | (° C.) | (h) | Y | P | 0.08Y | (%) | (° C.) |
| Example 2-3 | 10.0 | 1000 | 12 | 3 | 1.65 | 1.89 | 91.6 | 168 |
| Example 3-1 | 11.0 | 900 | 12 | 2.5 | 1.75 | 1.95 | 91.8 | 169 |
| Example 3-2 | 10.8 | 950 | 12 | 2.7 | 1.72 | 1.94 | 91.9 | 170 |
| Example 3-3 | 11.5 | 1000 | 10 | 2.8 | 1.77 | 1.99 | 91.8 | 171 |
| Example 3-4 | 11.5 | 1100 | 6 | 2.6 | 1.78 | 1.99 | 92.1 | 170 |
| Example 3-5 | 12.0 | 1000 | 8 | 2.5 | 1.8 | 2.00 | 92.0 | 170 |
| Example 3-6 | 12.0 | 900 | 15 | 2.8 | 1.83 | 2.05 | 91.9 | 169 |

According to Table 3, the relationship between the powder compacted density of the negative electrode active material and the mass percentage of silicon also affects the initial efficiency and thermal runaway temperature of the battery. When P+0.08Y satisfies 1.8 to 2.1, the initial efficiency and thermal runaway temperature of the battery are better. Further, when P+0.08Y satisfies 1.95 to 2.05, the initial efficiency and thermal runaway temperature of the battery are even better.

### Examples 4-1 to 4-6

These examples were substantially the same as Example 3-4, except that: the shaping time and classification yield of the graphitized material were controlled and adjusted, and (Dᵥ90−Dᵥ50)/Dᵥ99 and I_{d}/I_{g} of the negative electrode active material were changed. Specific parameters were shown in Table 4.

The initial coulombic efficiency and thermal runaway temperature of the above lithium-ion batteries were tested, and the results were shown in Table 4.

TABLE 4

| | | | | | | Thermal |
|---|---|---|---|---|---|---|
| | | Classifi- | | | | runaway |
| | Shaping | cation | (Dᵥ90 − | | Initial | temper- |
| | time | yield | Dᵥ50)/ | | efficiency | ature |
| | (h) | (%) | Dᵥ99 | I_{d}/I_{g} | (%) | (° C.) |
| Example | 4 | 65 | 0.17 | 0.55 | 92.1 | 170 |
| 3-4 | | | | | | |
| Example | 6 | 60 | 0.19 | 0.30 | 92.1 | 171 |
| 4-1 | | | | | | |
| Example | 5 | 55 | 0.15 | 0.35 | 92.0 | 171 |
| 4-2 | | | | | | |
| Example | 4 | 85 | 0.38 | 0.53 | 92.3 | 171 |
| 4-3 | | | | | | |
| Example | 3 | 80 | 0.38 | 0.56 | 92.3 | 171 |
| 4-4 | | | | | | |
| Example | 5 | 88 | 0.42 | 0.26 | 92.5 | 172 |
| 4-5 | | | | | | |
| Example | 6 | 86 | 0.37 | 0.30 | 92.5 | 171 |
| 4-6 | | | | | | |

According to Table 4, the particle size distribution and surface defect degree of the negative electrode active material also affect the initial efficiency and thermal runaway temperature of the battery. When 0.2≤(Dᵥ90−Dᵥ50)/Dᵥ99≤0.5, the initial efficiency and thermal runaway temperature of the battery are better. When I_{d}/I_{g}<0.5, the initial efficiency and thermal runaway temperature of the battery are better.

### Examples 5-1 to 5-6

These examples were substantially the same as Example 4-5, except that the shaping and classification yield and classification frequency (classification frequency affected particle size distribution; and a lower frequency resulted in a wider particle size distribution) were controlled to change TD and OI value of the negative electrode active material. Removing more fine powder reduced the yield but increased the TD of the negative electrode active material. Wider particle size distribution reduced the OI value of the active material. Specific parameters were shown in Table 5.

The initial coulombic efficiency and thermal runaway temperature of the above lithium-ion batteries were tested, and the results were shown in Table 5.

TABLE 5

| | Classifi- | Classifi- | | | | Thermal |
|---|---|---|---|---|---|---|
| | cation | cation | | | Initial | runaway |
| | yield | frequency | | OI | efficiency | temperature |
| | (%) | (Hz) | TD | value | (%) | (° C.) |
| Example | 88 | 20 | 0.65 | 7.0 | 92.5 | 172 |
| 4-5 | | | | | | |
| Example | 78 | 20 | 0.80 | 7.0 | 92.7 | 173 |
| 5-1 | | | | | | |
| Example | 70 | 18 | 1.05 | 6.5 | 92.8 | 173 |
| 5-2 | | | | | | |
| Example | 86 | 12 | 0.66 | 4.5 | 92.7 | 173 |
| 5-3 | | | | | | |
| Example | 85 | 13 | 0.68 | 5.0 | 92.8 | 174 |
| 5-4 | | | | | | |
| Example | 72 | 14 | 0.95 | 5.5 | 93.0 | 174 |
| 5-5 | | | | | | |
| Example | 60 | 10 | 1.20 | 4.0 | 92.9 | 174 |
| 5-6 | | | | | | |

According to Table 5, the tap density and OI value of the negative electrode active material also affect the initial efficiency and thermal runaway temperature of the battery. When 0.7≤TD≤1.2, the initial efficiency and thermal runaway temperature of the battery are better. When OI value is less than or equal to 6, the initial efficiency and thermal runaway temperature of the battery are better.

### Examples 6-1 to 6-6

These examples were substantially the same as Example 5-5, except that PD and K of the negative electrode sheet were changed. Specific parameters were shown in Table 6.

The initial coulombic efficiency and thermal runaway temperature of the above lithium-ion batteries were tested, and the results were shown in Table 6.

TABLE 6

| | | | | Thermal |
|---|---|---|---|---|
| | | | Initial | runaway |
| | PD | K | efficiency (%) | temperature (° C.) |
| Example 5-5 | 1.77 | 23 | 93 | 174 |
| Example 6-1 | 1.5 | 21 | 93.2 | 175 |
| Example 6-2 | 1.7 | 45 | 93.1 | 175 |
| Example 6-3 | 1.4 | 28 | 93.2 | 175 |
| Example 6-4 | 1.78 | 35 | 93.2 | 175 |
| Example 6-5 | 1.55 | 28 | 93.4 | 176 |
| Example 6-6 | 1.65 | 33 | 93.3 | 175 |

According to Table 6, the compacted density and porosity of the negative electrode sheet also affect the initial efficiency and thermal runaway temperature of the battery. When 1.45≤PD≤1.75, the initial efficiency and thermal runaway temperature of the battery are better. When 25≤K≤40, the initial efficiency and thermal runaway temperature of the battery are better.

Finally, it should be noted that the above embodiments are only used to illustrate the technical solutions of this application and are not intended to limit them. Although this application has been described in detail with reference to the foregoing embodiments, those of ordinary skill in the art should understand that the technical solutions described in the foregoing embodiments can still be modified, or some or all of the technical features can be equivalently replaced; and these modifications or replacements do not cause the essence of the corresponding technical solutions depart from the scope of the technical solutions of these embodiments of this application.

What is claimed is:

1. A negative electrode active material, comprising:
graphite particles; and
a silicon carbide layer disposed on a surface of the graphite particles, wherein a mass percentage Y % of silicon in the negative electrode active material and an average height Lc nm of the negative electrode active material along a c-axis direction satisfy:
$$0.3 \times ( 32 - Lc ) \leq Y \leq 0.9 \times ( 32 - Lc ) .$$

2. The negative electrode active material according to claim 1, wherein the silicon carbide layer has a thickness of 5 nm to 100 nm.

3. The negative electrode active material according to claim 1, wherein a crystal phase of silicon carbide in the silicon carbide layer is β-phase silicon carbide.

4. The negative electrode active material according to claim 1, wherein a specific surface area BET m²/g of the negative electrode active material and the mass percentage Y % of silicon in the negative electrode active material satisfy: 1.2≤BET−0.3×Y≤2.0.

5. The negative electrode active material according to claim 1, wherein a powder compacted density P g/cm³ of the negative electrode active material after being pressed under a pressure of 5-ton and the mass percentage Y % of silicon in the negative electrode active material satisfy: 1.80≤P+0.08×Y≤2.10.

6. The negative electrode active material according to claim 5, wherein 1.72≤P≤1.83.

7. The negative electrode active material according to claim 1, wherein a volume-based particle size of the negative electrode active material satisfies: 0.2≤(Dᵥ90−Dᵥ50)/Dᵥ99≤0.5.

8. The negative electrode active material according to claim 1, wherein a D-band intensity I_{d} of a Raman spectrum of the negative electrode active material and a G-band intensity I_{g} of the Raman spectrum of the negative electrode active material satisfy: I_{d}/I_{g}<0.5, and/or
a tap density TD g/cm³ of the negative electrode active material satisfies: 0.7≤TD≤1.2.

9. The negative electrode active material according to claim 1, wherein an orientation OI value of the negative electrode active material is less than or equal to 6.

10. The negative electrode active material according to claim 1, wherein 0<Lc<32.

11. The negative electrode active material according to claim 1, wherein 1.2≤Y≤5.9.

12. A secondary battery, comprising a positive electrode sheet, an electrolyte, and a negative electrode sheet; the negative electrode sheet comprising a negative electrode film layer; wherein the negative electrode film layer comprises a negative electrode active material, the negative electrode active material comprises graphite particles and a silicon carbide layer disposed on a surface of the graphite particles;
wherein a mass percentage Y % of silicon in the negative electrode active material and an average height Lc nm of the negative electrode active material along a c-axis direction satisfy: 0.3×(32−Lc)≤Y≤0.9×(32−Lc).

13. The secondary battery according to claim 12, wherein the silicon carbide layer has a thickness of 5 nm to 100 nm.

14. The secondary battery according to claim 12, wherein a powder compacted density P g/cm³ of the negative electrode active material after being pressed under a pressure of 5-ton and the mass percentage Y % of silicon in the negative electrode active material satisfy: 1.80≤P+0.08×Y≤2.10.

15. The secondary battery according to claim 12, wherein a volume-based particle size of the negative electrode active material satisfies: 0.2≤(Dᵥ90−Dᵥ50)/Dᵥ99≤0.5.

16. The secondary battery according to claim 12, wherein 0<Lc<32.

17. The secondary battery according to claim 12, wherein 1.2≤Y≤5.9.

18. The secondary battery according to claim 12, wherein an orientation OI value of the negative electrode active material is less than or equal to 6.

19. The secondary battery according to claim 12, wherein the negative electrode sheet satisfies at least one of the following conditions:
(1) a compacted density PD g/cm³ of the negative electrode sheet satisfies: 1.45≤PD≤1.75; or
(2) a porosity K % of the negative electrode sheet satisfies: 25≤K≤40.

20. An electronic device, comprising the secondary battery as claimed in claim 12.
